(19) United States
(12) Patent Application Publication
(10) Pub. No.: US 2019/0027088 A1
(43) Pub. Date: Jan. 24, 2019

(54) DISPLAY AND DYNAMIC DRIVING VOLTAGE COMPENSATION METHOD THEREOF

(71) Applicant: Acer Incorporated, New Taipei City (TW)

(72) Inventors: Wen-Hao YU, New Taipei City (TW); Chun-Chih KUO, New Taipei City (TW)

(21) Appl. No.: 16/007,048

(22) Filed: Jun. 13, 2018

(30) Foreign Application Priority Data
Jul. 21, 2017 (TW) 106124516

(51) Int. Cl. G09G 3/20

(52) U.S. Cl. CPC G09G 3/2096; G09G 2320/08; G09G 2370/08; G09G 2310/08

(57) ABSTRACT

A display is provided. The display includes a display panel and a timing controller. The timing controller controls the images displayed on the display panel according to a display driving signal from a host and the display driving configuration of the display panel. The timing controller determines whether there is an error in the display driving signal, and calculates an error count. The timing controller determines whether the error count is lower than a predetermined threshold. If so, the timing controller controls the display panel to display the display images normally according to the display driving signal. If not, the timing controller reports a display error signal to the host, so that the host dynamically updates the display driving configuration.

### CROSS REFERENCE TO RELATED APPLICATIONS

This application claims priority of Taiwan Patent Application No. 106124516, filed on Jul. 21, 2017, the entirety of which is incorporated by reference herein.

### BACKGROUND OF THE INVENTION

### Field of the Invention

The present invention relates to display apparatuses, and, in particular, to a display and dynamic driving voltage compensation method thereof.

### Description of the Related Art

Currently, an embedded DisplayPort (eDP) interface is used in many of the laptops on the market. In addition, the timing controller (TCON) in the display panel has a basic driving voltage compensation mechanism. For example, when the timing controller determines that the driving capability of the display signal from the host is insufficient, the timing controller may automatically raise the voltage level by one level. However, the driving capability required by the display panel may be insufficient due to long-term use or to there being different layouts of the printed circuit boards (PCBs) of the display panels from different manufacturers, which can result in the abnormal operation of the display panel.

During the verification stage of the display panel, it is ensured that the signal quality received by the display panel complies with design standards. For example, an eye diagram can be used to estimate the signal quality received by the display panel, and the center region of the eye diagram cannot be suppressed by the driving signal. However, due to there being different designs for PCBs used in display panels, the driving signal may be attenuated by the PCB, so that the display panel may receive an attenuated driving signal, and the center region of the eye diagram will be suppressed. Meanwhile, the timing controller may receive an erroneous driving signal that causes an erroneous display image, and thus the user may see a blurry image or defective pixels on the display panel.

FIG. 2A is a diagram of an eye diagram of an unsuppressed eDP interface signal. As illustrated in FIG. 2A, when the eye diagram of the eDP interface signal is unsuppressed, the center region 210 of the eye diagram may be in the shape of a complete polygon. Meanwhile, the timing controller may precisely determine the logic level (e.g. 0 or 1) of the driving voltage of each pixel in the display image, and there is no blurry image or defective pixels on the display panel.

FIG. 2B is a diagram of an eye diagram of a suppressed eDP interface signal. As illustrated in FIG. 2B, when the eye diagram of the eDP interface signal is suppressed, the center region 210 of the eye diagram may not be in the shape of a complete polygon. Meanwhile, the timing controller cannot precisely determine the logic level (e.g. 0 or 1) of the driving voltage of each pixel in the display image, resulting in blurred images or defective pixels on the display panel.

Accordingly, there is demand for a display and a dynamic driving voltage compensation method to solve the aforementioned problem.

### BRIEF SUMMARY OF THE INVENTION

A detailed description is given in the following embodiments with reference to the accompanying drawings.

In an exemplary embodiment, a display is provided. The display includes: a display panel; and a timing controller, for controlling display images of the display panel according to a display driving signal from a host and a display driving configuration of the display panel. The timing controller determines whether there is an error in the display driving signal, and calculates an error count. The timing controller determines whether the error count is lower than a predetermined threshold. If so, the timing controller controls the display panel to display the display images normally according to the display driving signal. If not, the timing controller reports a display error signal to the host, so that the host dynamically updates the display driving configuration.

In another exemplary embodiment, a dynamic driving voltage compensation method for use in a display is provided. The display includes a timing controller and a display panel. The method includes the steps of: utilizing the timing controller to control images displayed on the display panel according to a display driving signal from a host and the display driving configuration of the display panel; utilizing the timing controller to determine whether there is an error in the display driving signal and to calculate an error count; utilizing the timing controller to determine whether the error count is lower than a predetermined threshold; if so, utilizing the timing controller to control the display panel to display the display images normally according to the display driving signal; and if not, utilizing the timing controller to report a display error signal to the host, so that the host dynamically updates the display driving configuration.

### BRIEF DESCRIPTION OF THE DRAWINGS

The present invention can be more fully understood by reading the subsequent detailed description and examples with references made to the accompanying drawings, wherein:

FIG. 1 is a diagram of a computer system in accordance with an embodiment of the invention;

FIG. 2A is a diagram of an eye diagram of an unsuppressed eDP interface signal;

FIG. 2B is a diagram of an eye diagram of a suppressed eDP interface signal; and

FIG. 3 is a flow chart of a dynamic driving voltage compensation method for use in a display in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

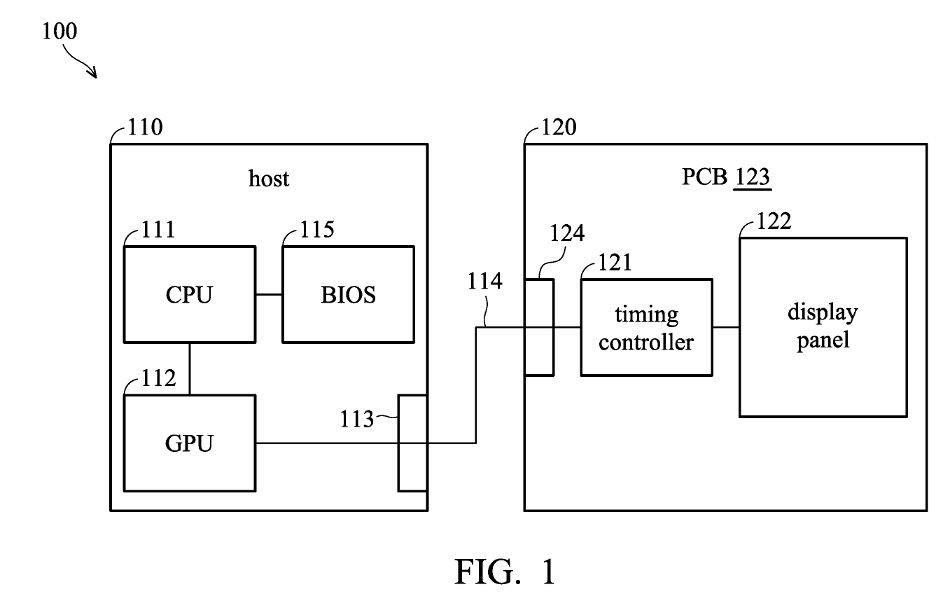

FIG. 1 is a diagram of a computer system in accordance with an embodiment of the invention. The computer system 100, for example, may be a laptop or a personal computer. As illustrated in FIG. 1, the computer system includes a host 110 and a display 120. The host 110 includes a central processing unit (CPU) 111, a graphics processing unit (GPU) 112, a transmission interface 113, and a basic input/output system (BIOS) 115. The display 120 includes a timing controller 121, a display panel 122, a printed circuit board (PCB) 123, and a display interface 124.

The transmission interfaces 113 and 124 may be an embedded DisplayPort (eDP) interface, but the invention is not limited thereto. The host 110 and the display 120 connect to each other via a data transmission cable 114 coupled between the transmission interfaces 113 and 124. The BIOS 115 may obtain information about the manufacturer and the product number of the display panel 122 from the display 120 via the transmission interface 113, thereby determining the swing level and the pre-emphasis level of the driving voltage of the display panel 122. Generally, the swing level and the pre-emphasis level obtained by the BIOS 115 are for setting the swing level and the pre-emphasis level of the display driving signal that is transmitted or received by the timing controller 121 of the display 120 and the GPU 112 of the host 110.

In an embodiment, the GPU 112 may be a graphics processing integrated circuit disposed in a stand-alone graphics card. In some embodiments, the GPU 112 can be integrated into the CPU 111, but the invention is not limited thereto.

In an embodiment, the GPU 112 may transmit a display signal to the display 120 via the transmission interface 113, and control the swing level and the pre-emphasis level of the driving voltage of the display signal, so that the timing controller 121 of the display 120 may correctly display the images on the display panel 122.

In another embodiment, the GPU 112 may utilize the existing display panel driving techniques to control the driving voltage of the display driving signal, such as using the iBoost technology developed by Intel™.

The timing controller 121 may receive the display driving signal from the host 110 via the transmission interface 124, and perform a voltage compensation process, and control the display panel 122 to display images using the compensated display driving signal.

In an embodiment, the swing level and the pre-emphasis level of the display driving signal output by the host 110 can be estimated using a standard VESA tool kit before the host 110 leaves the factory. For example, the display driving signal is usually estimated on the input terminal of the transmission interface 124 of the display 120. That is the display driving signal output from the host 110 may have a sufficient swing level and pre-emphasis level defined by the manufacturer in the BIOS 115 at the input terminal of the display 120 through the eDP data transmission cable 114. However, the display panels made by different manufacturers may have different swing levels and pre-emphasis levels.

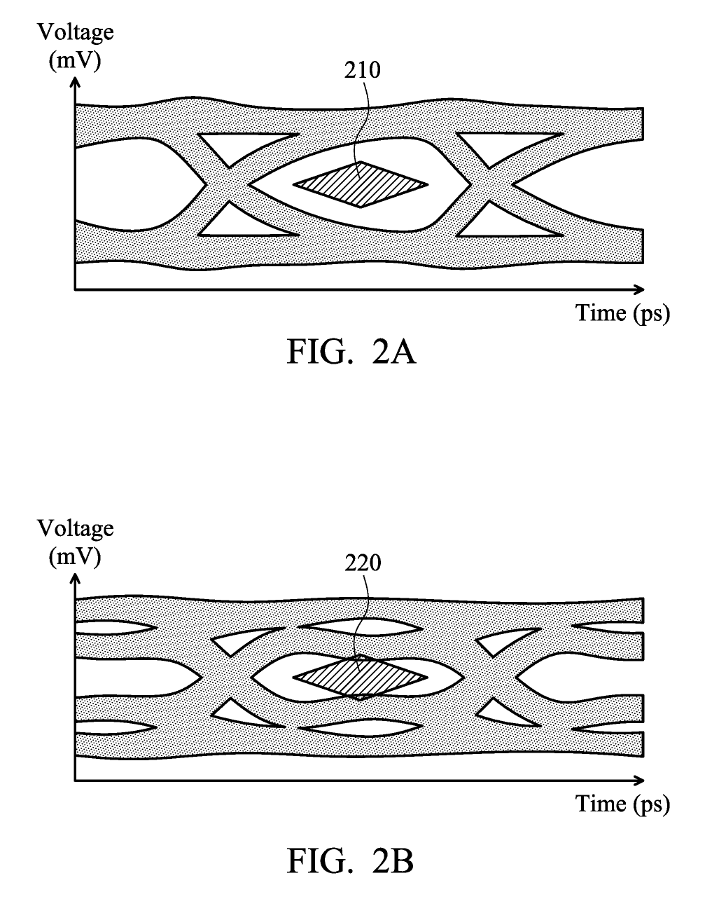

FIG. 2A is a diagram of an eye diagram of an unsuppressed eDP interface signal. The horizontal axis indicates time, and the vertical axis indicates voltage. The timing controller 121 may determine whether the display driving signal is at logic 1 or logic 0 according to the swing level. When the swing level is greater, it is easier for the timing controller 121 to determine the logic level of the display driving signal. However, the host 110 may consume more power to generate the display driving signal having a greater swing level. Generally, on the premise that the timing controller 121 may precisely determine the logic level of the display driving signal, it's better to have a smaller swing level, and thus the power consumption of the computer system can be reduced.

As illustrated in FIG. 2A, when the eye diagram of the eDP interface signal is unsuppressed, the center region 210 of the eye diagram may be in the shape of a complete polygon. Meanwhile, the timing controller 121 may precisely determine the logic level (e.g. 0 or 1) of the driving voltage of each pixel in the display image, and there is no blurred image or defective pixels on the display panel 122.

FIG. 2B is a diagram of an eye diagram of a suppressed eDP interface signal. As illustrated in FIG. 2B, when the eye diagram of the eDP interface signal is suppressed, the center region 210 of the eye diagram may not be in the shape of a complete polygon. Meanwhile, the timing controller 121 cannot precisely determine the logic level (e.g. 0 or 1) of the driving voltage of each pixel in the display image, resulting in blurred images or defective pixels on the display panel 122.

In an embodiment, when the computer system 100 is booting up, the BIOS may read the group of pictures (GOP) setting, and read the extended display identification data (EDID) from the display 120 to obtain information about the manufacturer and product number of the display panel 122 through the data transmission cable 114 and the transmission interface 113, thereby confirming corresponding parameters for driving the display panel 122, such as the swing level and the pre-emphasis level.

Then, the timing controller 121 may confirm the signal quality of the display driving signal from the host 110, and perform auto training. For example, the timing controller 121 may configure the display panel 122 according to the obtained parameters for driving the display panels. After configuring the display panel 122, the timing controller 121 may control the display panel 122 to display images normally. In the working state, the timing controller 121 may repeatedly determine whether the received display driving signal is unusual.

Each time when determining the received display driving signal is unusual, the timing controller may accumulate the error count (e.g. stored in a register of the timing controller 121) by 1. When the error count reaches a predetermined threshold, the timing controller 121 may determine that the display image on the display panel may have an unpredictable abnormal condition. Then, the timing controller 121 may report the accumulated error count to the host 110.

For example, the errors of the display driving signal may occur due to an insufficient swing level or pre-emphasis level, resulting in a suppressed center region of the eye diagram, and erroneous logic level of each pixel determined by the timing controller 121. Each time when the timing controller 121 has detected there is an error in the display driving signal, the error count is added by 1. In some embodiments, the error count may be an accumulated value of the errors after the computer system 100 has been booted up. In some embodiments, the error count may be the number of errors that is periodically calculated by the timing controller 121 within each time period.

Then, the BIOS 115 of the host 110 may update the swing level and/or pre-emphasis level of the display driving signal. In some embodiments, the existing technology such as iBoost technology developed by Intel can be used to dynamically adjust the swing level and/or the pre-emphasis level of the display driving signal from host 110. After the BIOS 115 updates the display driving configurations, the computer system 100 is rebooted to apply the updated display driving configurations.

For example, the initial swing level of the display panel 122 may be 400 mV and the initial pre-emphasis level may be 0 dB. However, the error count may be too high due to the initial settings of the swing level and the pre-emphasis level. Meanwhile, the timing controller 121 may report the error count to the host 110. Meanwhile, the BIOS 115 may update the configuration of the swing level being 400 mV and pre-emphasis level being 3.5 dB, thereby preventing the problem of a high error count.

In another embodiment, the BIOS 115 may keep the swing level being 400 mv and the pre-emphasis level being 0 dB, and the iBoost technology developed by Intel™ is used, thereby preventing the problem of a high error count.

In yet another embodiment, the BIOS 115 may update the swing level being 600 mV and the pre-emphasis level being 0 dB, thereby preventing the problem of a high error count.

It should be noted that different methods may be use to adjust the display driving configurations when the error count is too high due to different specifications of display panels of different manufacturers. In some situations, several adjustments are required to have a reasonable error count.

In one scenario, when the computer system 100 is booting up and the initial display driving configuration does not meet the requirements of the timing controller 121, the error count calculated by the timing controller 121 may rapidly reach the predetermined threshold, and the timing controller 121 may report the error count to the host 110. Then, the BIOS 115 may update the display driving configuration and reboot the computer system 100. As a result, the user may wait for a longer time during the booting of the computer system 100 without seeing erroneous display images.

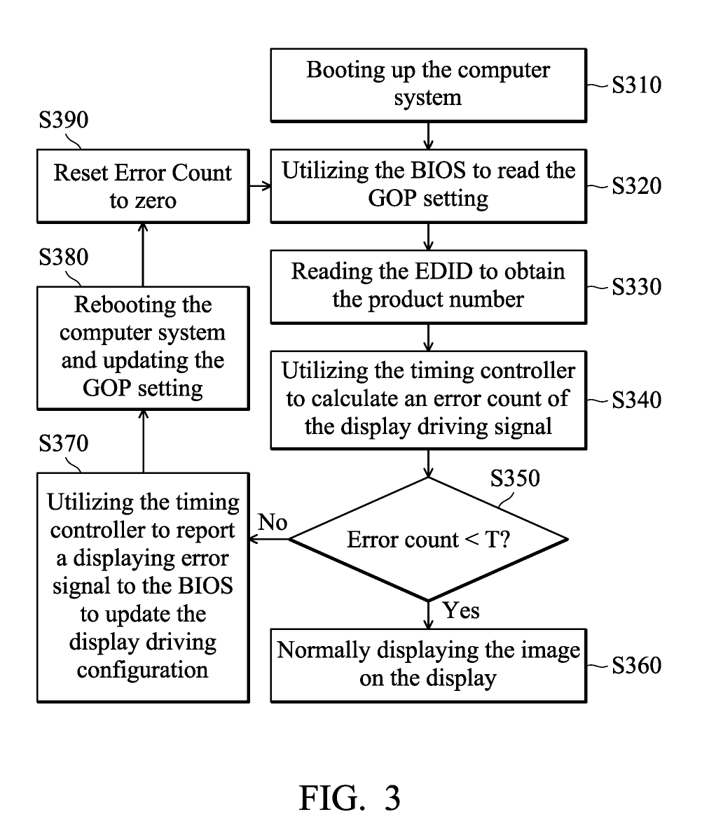

FIG. 3 is a flow chart of a dynamic driving voltage compensation method for use in a display in accordance with an embodiment of the invention. Referring to FIG. 1 and FIG. 3, in step S310, the computer system 110 is booting up. In step S320, the BIOS 115 reads a GOP setting.

In step S330, the EDID of the display panel 122 is read to obtain a product number of the display panel 122. Meanwhile, the host 110 and the timing controller 121 may obtain the display driving configuration of the display panel and the operation modes of the swing level and pre-emphasis level according to the retrieved product number of the display panel 122.

In step S340, the timing controller 121 is utilized to calculate an error count of the display driving signal from the host 110.

In step S350, it is determined whether the error count is lower than a predetermined threshold T. If so, the display 120 may display images normally. Otherwise, the timing controller 121 may report a display error signal (or the error count) to the BIOS 115 to update the display driving configuration (step S370).

In step S380, the computer system 100 is rebooted and the GOP setting is updated.

In step S390, the error count is reset to zero. For example, after the computer system 100 is rebooted and the GOP setting is updated, the timing controller 121 may reset the error count. Then, step S320 is performed.

In view of the above, a display and a dynamic driving voltage compensation method thereof is provided. The display and the method are capable of repeatedly detecting by the timing controller whether there is an error in the display driving signal from the host, and calculating an error count. When the error count reaches the predetermined threshold, the timing controller may report the error count or an associated display error signal to the host, so that the BIOS may dynamically update the display driving configuration of the display, and the display errors of the display panel caused by an attenuated display driving signal of the display panels made by different manufacturers can be solved.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display, comprising:
a display panel; and
a timing controller, for controlling display images of the display panel according to a display driving signal from a host and a display driving configuration of the display panel,
wherein the timing controller determines whether there is an error in the display driving signal, and calculates an error count,
wherein the timing controller determines whether the error count is lower than a predetermined threshold,
if so, the timing controller controls the display panel to display the display images normally according to the display driving signal,
if not, the timing controller reports a display error signal to the host, so that the host dynamically updates the display driving configuration.

2. The display as claimed in claim 1, wherein the timing controller receives the display driving signal via an embedded DisplayPort (eDP) interface.

3. The display as claimed in claim 1, wherein the display driving configuration comprises a swing level and/or a pre-emphasis level of the display driving signal.

4. The display as claimed in claim 1, wherein the display driving configuration is dynamically updated using the iBoost technology developed by Intel™.

5. The display as claimed in claim 1, wherein a basic input/output system (BIOS) of the host is used to update the display driving configuration of the display panel.

6. A dynamic driving voltage compensation method for use in a display, wherein the display comprises a timing controller and a display panel, the method comprising:
utilizing the timing controller to control display images of the display panel according to a display driving signal from a host and a display driving configuration of the display panel;
utilizing the timing controller to determine whether there is an error in the display driving signal and to calculate an error count;
utilizing the timing controller to determine whether the error count is lower than a predetermined threshold;
if so, utilizing the timing controller to control the display panel to display the display images normally according to the display driving signal; and
if not, utilizing the timing controller to report a display error signal to the host, so that the host dynamically updates the display driving configuration.

7. The method as claimed in claim 6, wherein the timing controller receives the display driving signal via an embedded DisplayPort (eDP) interface.

8. The method as claimed in claim 6, wherein the display driving configuration comprises a swing level and/or a pre-emphasis level of the display driving signal.

9. The method as claimed in claim 6, wherein the display driving configuration is dynamically updated using the iBoost technology developed by Intel™.

10. The method as claimed in claim 6, further comprising:
utilizing a basic input/output system (BIOS) of the host to update the display driving configuration of the display panel.
